(19) United States
(12) Patent Application Publication
(10) Pub. No.: US 2015/0306667 A1
(43) Pub. Date: Oct. 29, 2015

(54) Utilization of Partial Sintering to Avoid the Use of Support Structures in the Direct Metal Laser Sintering Additive Manufacturing Processes

(71) Applicant: Shi-chune Yao, Pittsburgh, PA (US)

(72) Inventor: Shi-chune Yao, Pittsburgh, PA (US)

(21) Appl. No.: 14/690,507

(22) Filed: Apr. 20, 2015

Related U.S. Application Data
(60) Provisional application No. 61/995,875, filed on Apr. 24, 2014.

(51) Int. Cl. B22F 3/105; B23K 26/34; B22F 7/02

(52) U.S. Cl. CPC B22F 3/1055; B22F 7/02; B23K 26/345; B33Y 10/00

(57) ABSTRACT

This invention is focused on a new method of the Direct Metal Laser Sintering (DMLS) additive manufacturing process, which builds metal products layer-by-layer from melting the powder at selective locations. In the conventional DMLS process, during the process of building a downward facing surface of products, such as making a ceiling of a box or the top of a horizontal pipe, commonly a temporary support structure is applied at below to let the new layer of molten metal to rest upon. In this invention, the partially sintered layer (or layers) will be used instead, to form a rigid base for the subsequent molten layer at above to rest upon. The partial sintering is achieved with a reduced heating of laser that the powder reaches a high temperature but still below the melting point. This invention will allow for the elimination of the use of temporary support structures, and the time and effort of adding and removing of the temporary support structures are saved.

### CROSS-REFERENCE TO RELATED APPLICATIONS

This application claims priority to U.S. Provisional Application Ser. No. 61/995,875, titled Utilization of Partial Sintering to Avoid the Use of Support Structures in the Direct Metal Laser Sintering Additive Manufacturing Processes, filed Apr. 24, 2014, incorporated by reference herein in its entirety.

### STATEMENT REGARDING FEDERALLY-SPONSORED RESEARCH AND DEVELOPMENT

Not Applicable

### FIELD OF THE INVENTION

This patent addresses a particular methodology, which can be applied in the layer-by-layer additive manufacturing process of using laser to make metal products. This invention describes a new method of utilizing the partial sintering of powders to avoid the use of temporary support structures in building the downward facing surfaces of products, such as the ceiling of a box or the top of a horizontal tube, etc. As a result, the tedious efforts of adding and removing the temporary metal support structures and polishing the residuals at surfaces are eliminated.

### BACKGROUND

In the Direct Metal Laser Sintering (DMLS) processes of additive manufacturing the metal powder is spread as a layer on solid, and a heat source of laser is applied at selected locations to melt the powder onto the partially-made product at below. The laser power must be high enough that the powder layer is fully sintered, with little porosity, into molten metal and then freezes on the solid at below. Then, another layer of metal powder is added on top of this layer and melted by laser again. The metal product is therefore manufactured additively layer-by-layer through converting the powder into solid metal.

It is known to those skilled in the art that when this process is applied to a downward facing surface such as the ceiling of a box or the top of a horizontal tube, correct structural configuration is hard to be achieved. In fact, this is because at these locations the edge of the new layer extends outwards into the powder zone that the material at below is not a solid, but is the powder, which is not able to support the new layer of molten metal on its top during the formation. Then, failure of construction occurs at this location [1]. In practice, known to those skilled in the art, temporary support structures are applied below the ceiling or arch [1]. The major function of the support structure is to allow the layer of molten metal to rest upon. It is a common rule-of-thumb of those skilled in the art that for a product with a downward facing surface at an angle less than 30° from the horizontal line the temporary support structure must be applied. In reality, for those skilled in the art, the locations and the structures of temporary support are determined empirically based upon experience, and sometimes fail to accomplish the goal.

The reason of the failure in constructing a ceiling of a box or the top of a tube is because at these downward facing locations the molten layer of metal extends outwards, and is anchored on the powder instead of solids. It is well known that molten metal has a very large surface tension (for example, the mercury forms into drops due to the large surface tension of liquid metal). Without a solid at below to be anchored upon, the molten layer of metal shrinks into small metal balls or rods. This is shown schematically in FIG. 1. As a result, these downward facing structures are not able to be built as desired. That is also the reason the conventional support structure is required to be applied under the arches.

These supports are general porous in structure and must be removed after the additive manufacturing of the product is completed, which could be conducted by those skilled in the art using EDM (electro-discharge machining) or grinding etc.; however, this removal process is difficult and time consuming. Especially in many cases the support structure could be at inaccessible locations, such as in the winding cooling-channels in the dies of injection molding. This invention intends to eliminate the adding and the removing of these temporary support structures.

### BRIEF SUMMARY OF THE INVENTION

The major element in this invention is the use of partially sintered powder to support the molten metal layer during the process. Regularly, the power of the sweeping laser in DMLS must be high enough to fully melt the powder layer that it could connect to the solid at below. Now, in the partial sintering process, the laser will be applied at a reduced power of the regular intensity that the powder layer is heated to a high average temperature but still below the melting point, and the powders are only partially sintered but not fully molten. As shown schematically in FIG. 2, a firm structure of partially sintered layer is formed. The partial sintering means the particles are not fully molten, but the contacting points among particles are fused into necking connections. The partially sintered powder is therefore rigid and is kept in the original shape.

Then, the full sintering can be applied on top, in one of the three types of method. In first two methods, simply build a next fully sintered layer at the regular laser power on top of this partially sintered layer, as shown in FIG. 3, or on several stacked partially sintered layers, which act as a stronger support as shown in FIG. 4. Or, in the third method, another laser sweep is applied to this first partially sintered layer at a fraction of the regular power that only the upper portion of the partially sintered layer is molten, while the lower portion of the layer is still rigid as before. As shown in FIG. 5, this layer will become a full solid at the upper portion and resting on the partially sintered solid of well-maintained configuration at the lower portion. In any of these methods, many regular power layers can be built subsequently on top to form the downward facing surfaces of products with good thicknesses. The use of temporary support structures can therefore be avoided, and the time and effort of adding and removing the temporary support structures can be saved. With this invention, the additive manufacturing products will have lower cost, better quality, and faster delivery.

### BRIEF DESCRIPTION OF THE DRAWINGS

FIG. 1. FIG. 1 is the schematics of the making of a layer on top of the powder in the conventional method, where (a) is the situation before the powder layer is molten and (b) is the situation after the powder is molten, but surface tension pulls the molten metal into drops or rods.

FIG. 2. FIG. 2 illustrates schematically the invention, showing the powder is partially sintered at reduced laser power that the configuration is preserved.

FIG. 3. FIG. 3 shows a second layer on top of this partially sintered layer is built with regular laser power that the new layer melts totally and rests upon the lower partially sintered layer.

FIG. 4. FIG. 4 shows another method that there are several partially sintered layer at below to support the new layer of solid built with regular laser power.

FIG. 5. FIG. 5 shows that on top of the partially sintered layer the addition of another laser sweep on the same layer at reduced power melts the upper portion of the layer to form a solid, but rests upon the rigid lower portion of the layer.

### DETAILED DESCRIPTION AND BEST MODE OF IMPLEMENTATION

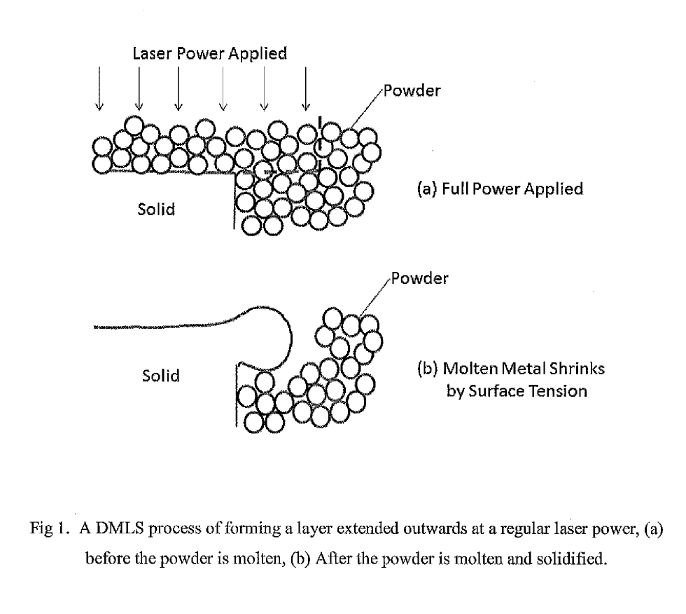

In the DMLS process, the metal powder is transformed into solid by the laser power. The laser power should be high enough to melt the powder layer totally and to connect with the partially formed solid product at below. While the product is build layer-by-layer upwards, there will be places the product has a downward facing surface. Typically, this occurs at the ceiling of a box, at the top of a horizontal tube, or an arch, where the edge of the to-be-formed layer is resting upon the powder instead of a solid product. The local configuration is shown schematically in the FIG. 1(a), where the dash line indicates the desired location of the new layer extending into the powder zone, In a conventional DMLS process, when the laser power is applied to this layer, the powder in this region, which extends into the powder zone, is molten. However, the powder at below is not able to hold the layer of molten metal in place; instead, the strong surface tension of molten metal pull the metals at the edge to form drops or rods. This is shown schematically in the FIG. 1(b). When building the next layer on top, same problem occurs that the formed product will fail to extend sufficiently into the powder zone. Eventually the construction of the product fails.

This invention is based upon the utilization of “partial sintering”, in which the contact interfaces among the particles in the powder are fused into necking connections, but the body of the particles and the configuration of the powder are still intact. This is different from the full sintering occurring in the regular DMLS processes, where all the powders are molten totally during the process, and if without the support of adjacent solid, the molten metal forms into ball or rods by the large surface tension, as shown in FIG. 1(b).

The energy per unit area, E/A, to achieve the full melting of one powder layer is (E/A)_{full-melt}. In this patent, the “partial sintering” means the applied energy per unit area is a fraction of that of full melting of one layer of powder. This means

(E/A)_{partial-sintering}<(E/A)_{full-melt} (1)

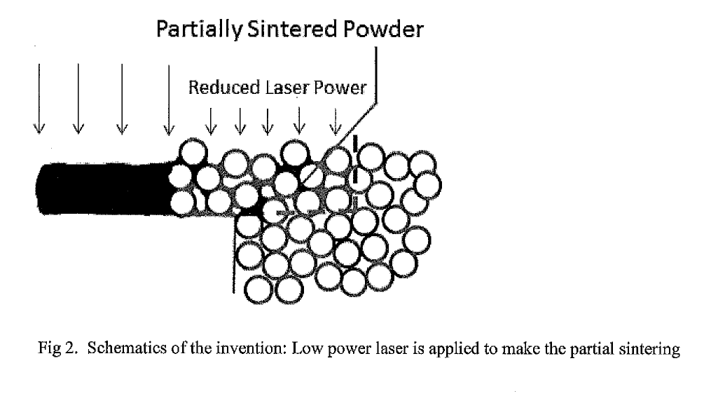

This invention utilizes the partial sintering of powder to create a rigid body of the extended portion of the layer that, at later moment, the molten metal of the next higher layer can rest upon. It is well known that at an average temperature near but below the melting point the powder will partially sinter and form a rigid body [2]. In the present situation, a reduced laser power can be applied to the powder layer that the partial sintering of the powder could occur. As a result, the layer of powder extended outwards into the powder zone becomes a partially sintered rigid body, as shown schematically in the FIG. 2.

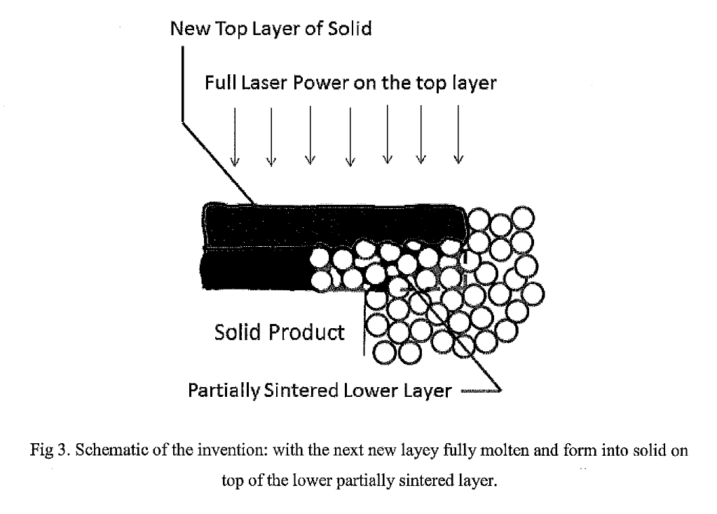

In the DMLS, each layer is very thin, typically 30 micron. Therefore, the present layer extending outwards is the partially sintered layer, but the next layer on its top could be built with the regular full laser power, which melts this new top layer totally but rests upon the previous partially sintered layer at below. The final result will be a partially sintered layer at below and a solid layer on its top, as shown schematically in FIG. 3.

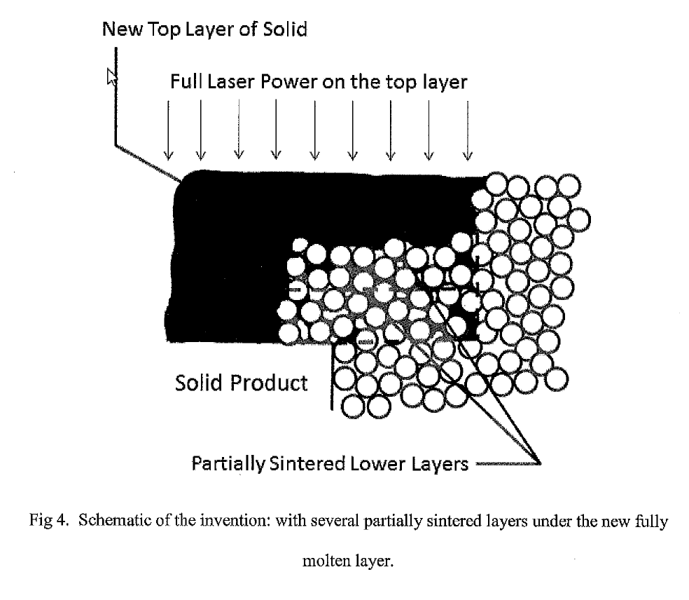

For applications wish to build thicker and stronger partially sintered supports at below, another alternative method can be used. This method is to make several stacked partially sintered layers first, then to apply a fully molten layer on top to form a solid. This is shown schematically in FIG. 4, using multiple layers of partially sintered powders at below, with same or different extents of partial sintering, instead of using only one layer as in FIG. 3, to provide a stronger support for the solid layers on top.

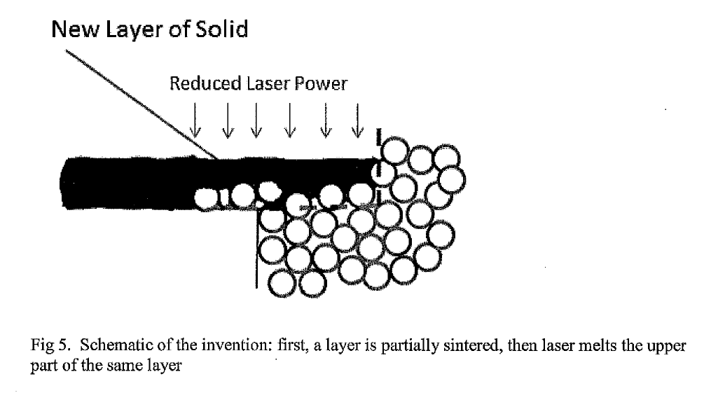

Another alternative of this invention is to build the partially sintered layer first, then apply another laser sweep at reduced power than the regular power on this same partially sintered layer that only the top portion of this partially sintered layer is fully molten while the lower portion is still the original rigid partially sintered body. With the presence of the rigid lower portion, the molten metal at the upper part of the layer will not shrink into metal balls or rods. As shown in the FIG. 5, the configuration of this new layer can be preserved in the desired geometry.

The use of partially sintered powder layer in DMLS to build downward facing surfaces of products will help to avoid the use of the conventional temporary support structures. The time and effort of adding and removing the temporary support structures will be saved. With this invention, the additive manufacturing products will have lower cost, better quality, and faster delivery.

### REFERENCES

1. A. Galloway, “How to Design for Additive Manufacturing Technology Direct Metal Laser Sintering (DMLS),” Proceedings RAPID 2013 Conference, Pittsburgh, Jun. 12, 2013.
2. O. Lame, D. Bellet, M. DiMichiel, and D. Bouvard, “Bulk Observation of Metal Powder Sintering by X-ray Synchrotron Micro-tomography,” Acta Materialia, Vol. 52, Issue 4, 2004, pp. 977-984.

What is claimed is:

1. A method for making metal products using a Direct Metal Laser Sintering (DMLS) process comprising steps of:
a first step of applying a first layer of powder on a surface;
a second step of partial sintering (defined in equation (1)) said layer of powder to construct a support structure, as shown in FIG. 2;
a third step of applying a second layer of powder on the partially sintered said first layer of power;
a fourth step of melting said second layer of powder, as shown in FIG. 3, and
repeating the third and the fourth steps to construct the product,
whereby downward facing surfaces of a product can be made without a need to construct a temporary support structure.

2. The method of claim 1, wherein said partial sintering being achieved by a laser at a low power.

3. The method of claim 1, wherein said melting being achieved by a laser at a high power.

4. The method of claim 1, wherein said method of partial sintering a powder comprising of heating a powder to a high average temperature but still below the melting point of said powder, whereby only a necking of the contact areas of powder particles occurs without fully melting.

5. The method of claim 4, wherein said partial sintering being obtained by a laser means, wherein said laser being operated at reduced power of heating than its normal operating power in the DMLS devices to have total melting of the powder in a powder layer.

6. The method of claim 5, wherein said reduced power heating being by sweeping a laser on a powder layer at a faster speed than usual, or by sweeping at a regular power but at a lower power, or by combinations of laser powers and sweeping speeds.

7. A method for making metal products using a Direct Metal Laser Sintering (DMLS) process comprising steps of
a first step of applying a first layer of powder on a surface;
a second step of partial sintering (defined in equation (1)) said layer of powder to construct a support structure;
an option of repeating the first and the second steps for one or more times, at same or different extents of partial sintering, to construct additional layers of partially sintered powder product, whereby said partially sintered powdered product being sturdy enough to act as a support structure to build a product on, as shown in FIG. 4;
a third step of applying a new layer of powder on the partially sintered structure;
a fourth step of melting said new layer of powder, and
repeating the third and the fourth steps to construct the product.

8. The method of claim 7, wherein said method of partial sintering a powder comprising of heating a powder to a high average temperature but still below the melting point of said powder, whereby only a necking of the contact areas of powder particles occurs without fully melting.

9. The method of claim 8, wherein said partial sintering being obtained by a laser means, wherein said laser being operated at reduced power of heating than its normal operating power in the DMLS devices to have total melting of the powder in a powder layer.

10. The method of claim 9, wherein said reduced power heating being by sweeping a laser on a powder layer at a faster speed than usual, or by sweeping at a regular speed but at a lower power, or by combinations of laser powers and sweeping speeds.

11. A method for making metal products using a Direct Metal Laser Sintering (DMLS) process comprising steps of:
a first step of applying a first layer of powder on a surface;
a second step of partial sintering said layer of powder to construct a support structure;
a third step of melting the upper portion of said layer of partially sintered powder, as shown in FIG. 5, and
a fourth step of applying a second layer of powder on the first layer structure;
a fifth step of melting said second layer of powder, and
repeating the fourth and the fifth steps to construct the product.

12. The method of claim 11, wherein the laser power in the third steps being high enough to melt the powder at the upper portions of the partially sintered layer, but low enough to not melt the lower portions of the partially sintered layer.
